(19) United States
(12) Patent Application Publication
(10) Pub. No.: US 2014/0023825 A1
(43) Pub. Date: Jan. 23, 2014

(54) SURFACE PROTECTION SHEET

(71) Applicant: NITTO DENKO CORPORATION, Osaka (JP)

(72) Inventors: Takeshi IGARASHI, Osaka (JP); Toshitaka SUZUKI, Osaka (JP); Nao WAKAYAMA, Osaka (JP)

(21) Appl. No.: 13/942,923

(22) Filed: Jul. 16, 2013

(30) Foreign Application Priority Data
Jul. 18, 2012 (JP) 2012-159198

(51) Int. Cl. C09J 7/02

(52) U.S. Cl. CPC C09J 7/021
USPC 428/141; 428/336; 428/219; 428/220

(57) ABSTRACT

The present invention provides a surface protection sheet comprising a PSA layer having a thickness smaller than 10 μm on a support substrate. The surface protection sheet exhibits a holding time of 50 seconds or longer in a constant load peel test comprising: pressure-bonding a 25 mm wide piece of the surface protection sheet to a painted plate prepared by coating a steel plate with an acid-epoxy crosslinked acrylic paint; and at 5 minutes after the pressure-bonding of the surface protection sheet, applying a 100 g load to a first edge of the surface protection sheet piece so as to yield a peel angle of 90°; with the holding time being the time spent by the surface protection sheet piece after the application of the load until 5 cm thereof was peeled off.

### CROSS-REFERENCE

The present application claims priority based on Japanese Patent Application No. 2012-159198 filed on Jul. 18, 2012, and the entire contents thereof are incorporated herein by reference.

### BACKGROUND OF THE INVENTION

1. Field of the Invention

The present invention relates to a surface protection sheet for protecting the surface of an adherend from damages such as scratches, dirt deposits, and so on.

2. Description of the Related Art

During processing or transporting metal plates, painted steel plates, or synthetic resin plates, etc., as a known means to prevent their surfaces from receiving damages (scratches, dirt deposits, etc.), protection sheets are adhered to the surfaces. A surface protection sheet used for such a purpose is generally constructed to comprise a pressure-sensitive adhesive (PSA) layer on one face of a resin substrate sheet (support substrate) so that it can serve the protective purpose when adhered via the PSA layer to an adherend (an article to be protected). For example, for constituting a PSA layer in a surface protection sheet used on paint finishes of automobiles, use of a polyisobutylene-based PSA is known (Japanese Patent No. 2832565). Japanese Patent Application Publication No. H9-3420 discloses a coating film-protective sheet that comprises a support substrate provided with a rubber-based PSA layer containing a highly polar inducer. Other technical literature relating to paint film-protective sheets includes Japanese Patent No. 2832579.

### SUMMARY OF THE INVENTION

In general, surface protection sheet is temporarily adhered to an adherend while the adherend needs to be protected (e.g., during the process or transport, etc., is ongoing). Subsequently, after use as a protective means, the protection sheet is removed (peeled away) from the adherend. It is desired for a surface protection sheet used in such an embodiment to have a property (initial adhesiveness) that produces sufficiently tight adhesion quickly after adhered to adherends. This is because, if the initial adhesiveness of the surface protection sheet is insufficient, the efficiency in carrying out the task of applying the protection sheet to an adherend may become lower, or the applied surface protection sheet may partially come off the adherend, being unable to serve the protection purpose. When applied to an adherend having an uneven surface (especially, an adherend having a complex tridimensional configuration such as surfaces of vehicles including automobiles, etc.), or when the adhesion area is relatively large, etc., it is especially meaningful to increase the initial adhesiveness of the surface protection sheet. The level of the initial adhesiveness can be evaluated, for instance, by the length of holding time in the constant load peel test described later. In other words, a surface protection sheet exhibiting a longer holding time can produce greater initial adhesiveness.

It is preferable to have a thinner PSA layer in a surface protection sheet as it can contribute to save resources or energies required for formation of the PSA layer. With a thinner PSA layer, however, the surface protection sheet tends to exhibit poorer initial adhesiveness. Thus, an objective of the present invention is to provide a surface protection sheet that comprises a PSA layer having a small thickness, yet exhibits great initial adhesiveness.

The present description provides a surface protection sheet comprising a support substrate and a PSA layer placed on the support substrate. The PSA layer has a thickness smaller than 10 μm. The surface protection sheet exhibits a holding time of 50 seconds or longer in a constant load peel test using, as an adherend, a painted plate prepared by coating a steel plate with an acid-epoxy crosslinked acrylic paint, with the test comprising:

pressure-bonding a 25 mm wide piece of the surface protection sheet to the adherend;

at 5 minutes after the pressure-bonding of the surface protection sheet, applying a 100 g load to a first edge of the surface protection sheet piece so as to yield a peel angle of 90°; and

measuring, as the holding time, time spent by the surface protection sheet piece after the application of the load until 5 cm thereof was peeled off.

A surface protection sheet comprising a PSA layer having a thickness as small as less than 10 μm and exhibiting a long holding time in the constant load peel test can achieve high levels of resource and energy saving as well as great initial adhesiveness at the same time.

The PSA layer preferably has a surface having an arithmetic mean roughness (Ra) of 1.0 μm or smaller. A surface protection sheet comprising such a PSA layer is likely to exhibit great initial adhesiveness even if the thickness of the PSA layer is smaller than 10 μm.

The PSA layer is constituted preferably with a PSA comprising a non-crosslinked polymer as a primary component. Such a PSA layer is less likely to accumulate internal strain inside the PSA layer; thereby being less likely to cause stress to an adherend surface even if the PSA layer has a small thickness. For example, a preferable PSA comprises a non-crosslinked polymer as a base polymer.

A PSA preferably used for constituting the PSA layer comprises an isobutylene group represented by the following formula (I):

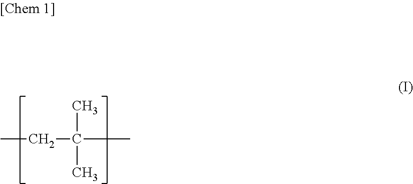

For example, a preferable surface protection sheet comprises a PSA layer in which the mass ratio of the isobutylene group to the PSA is 5% or greater.

A PSA constituting the PSA layer may comprise a tackifier resin (Tₕₛ) having an SP value of 8.5 or larger. In this case, the mass ratio of the tackifier resin (Tₕₛ) to the PSA can be, for instance, 0.05 to 5.0% by mass. According to a PSA having such a composition, the resulting surface protection sheet is likely to exhibit great initial adhesiveness even when the thickness of the PSA layer is smaller than 10 μm.

The surface protection sheet according to a preferable embodiment comprises, as the support substrate, a support substrate having an average light transmittance of 10% or lower in a wavelength range of 300 nm to 350 nm. A surface protection sheet comprising such a support substrate is preferable since the PSA layer is less likely to undergo degradation by ultraviolet (UV) rays.

In a preferable embodiment of a surface protection sheet disclosed herein, the surface protection sheet has a mass per unit area of 60 g/m² or less. That is, a preferable surface protection sheet has a grammage of 60 g/m² or less. A surface protection sheet having such a small mass per unit area is preferable because, for instance, in an embodiment where the surface protection sheet is wound in a roll and included in a roll body, it allows reduction of the mass of the roll body. It is preferable also because according to a surface protection sheet having a small mass per unit area, the length of the surface protection sheet included in the same mass of the roll body can be increased.

The present description provides a protection sheet roll (a roll body) comprising a surface protection sheet disclosed herein. The surface protection sheet included in the protection sheet roll is a long strip having a length of 200 m or longer and is wound in its length direction. The protection sheet roll has a mass of 0.75 kg or less per 50 mm width of the surface protection sheet. As such, a protection sheet roll comprising a surface protection sheet having a prescribed length or a longer length and a mass suppressed to a prescribed level or below is preferable from the standpoint of the handling properties of the protection sheet roll or the workability of applying the surface protection sheet to adherends, etc.

### BRIEF DESCRIPTION OF THE DRAWINGS

FIG. 1 shows a cross-sectional view schematically illustrating an embodiment of the surface protection sheet according to the present invention.

FIG. 2 shows a perspective view schematically illustrating a form of the protection sheet roll according to the present invention.

FIG. 3 shows a diagram illustrating a method of a constant load peel test.

### DETAILED DESCRIPTION OF THE INVENTION

Preferred embodiments of the present invention are described below. Matters necessary to practice this invention other than those specifically referred to in this description may be understood as design matters based on the conventional art in the pertinent field for a person of ordinary skill in the art.

The present invention can be practiced based on the contents disclosed in this description and common technical knowledge in the subject field.

### [Constitution and Properties of Surface Protection Sheet]

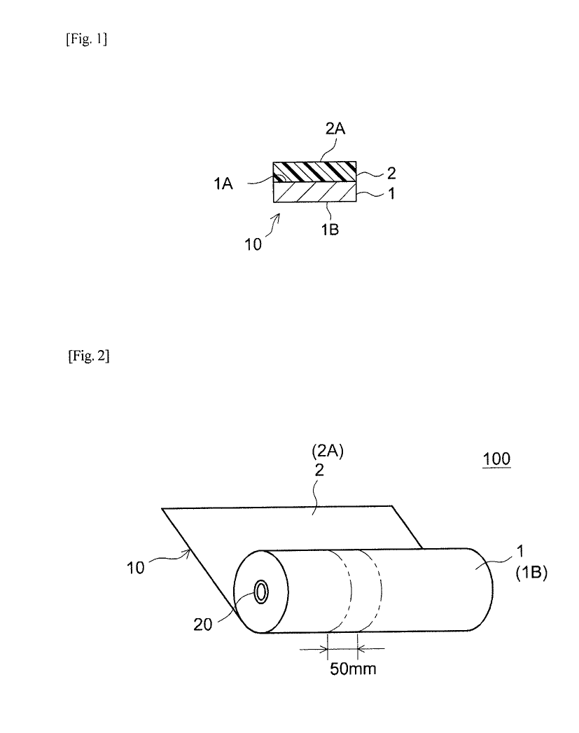

The surface protection sheet disclosed herein comprises a support substrate and a PSA layer placed on the support substrate. FIG. 1 shows a cross-sectional constitution of the surface protection sheet according to an embodiment of the present invention. A surface protection sheet 10 has a constitution in which a first face 1A of a support substrate sheet 1 retains a PSA layer 2, and when used, it is adhered to an adherend via a surface 2A of the PSA layer 2. Herein, the term “adherend” refers to an article to be protected by the surface protection sheet 10. The article to be protected may be, for instance, an article having a paint film such as automobiles and their components, etc. In other words, the protection sheet 10 may be an automobile paint-film protection sheet used for protecting automobiles and their components.

Prior to use (i.e., before adhered to the adherend), the protection sheet 10 may be present such that the surface (an adhesive face, i.e., a surface to be adhered to the adherend) 2A of the PSA layer 2 is protected with a release liner (not shown in the drawing) having a release surface at least on the PSA layer side. Alternatively, the protection sheet 10 may be present such that the protection sheet 10, with a second face (back face) 1B of the support substrate 1 being a release face, is wound in a roll such that the second face contacts the PSA layer 2 and protects the surface (adhesive face) 2A.

The surface protection sheet disclosed herein is characterized by the PSA layer having a thickness smaller than 10 μm. Such a thin PSA layer is preferable because as compared to a thicker PSA layer (e.g., a PSA having a thickness of 10 μm or larger), it may allow saving of resources or energies required for formation of the PSA layer. According to such a thin PSA layer, a surface protection sheet comprising the PSA layer and a support substrate can have a smaller overall thickness. This is advantageous in view of reducing the costs of storage and transport of the surface protection sheet. In the surface protection sheet according to a preferable embodiment, the PSA layer has a thickness of 8 μm or smaller, or more preferably 7 μm or smaller, for example, 6 μm or smaller.

The lower limit of the thickness of the PSA layer is not particularly limited as long as a surface protection sheet comprising the PSA layer exhibits desirable properties (e.g., a desirable holding time in the constant load peel test). It is usually suitable that the PSA layer has a thickness of 2 μm or larger, or preferably 3 μm or larger (e.g., 4 μm or larger).

The art disclosed herein can be practiced preferably in the form of a surface protection sheet comprising a PSA layer having a thickness of 2 μm or larger, but smaller than 10 μm (more preferably 3 μm or larger, but 8 μm or smaller, e.g., 4 μm or larger, but 6 μm or smaller). For example, the ranges given above can be preferably employed for the thickness of a PSA layer contained in an automobile paint-film protection sheet.

The thickness of the PSA layer is defined as an arithmetic mean value of thickness values measured by a 1/10000 dial gauge at five different locations. For example, the overall thickness of a surface protection sheet comprising a PSA layer and a support substrate is measured at five different locations, and then the thickness of the surface protection sheet is measured again after the PSA layer is removed at five different locations. The thickness of the PSA layer can be determined as the difference in the measured thickness. As a method for removing the PSA layer from the surface protection sheet, can be suitably employed a method where the PSA layer is dissolved in a suitable organic solvent such as toluene, etc., a method where the PSA layer is swollen with the organic solvent and scraped off, or like methods.

The PSA layer in the art disclosed herein may have a single-layer structure, or a layered structure with two or more layers. For a layered structure, the thickness of the PSA layer refers to their combined thickness.

The surface protection sheet disclosed herein satisfies the following property (A): in the constant load peel test (which is carried out more specifically based on the constant load peel test described later in Example 1), it exhibits a holding time of 50 seconds or longer.

A long holding time indicates greater peel properties under a constant load, and thus, higher initial adhesiveness. A preferable surface protection sheet exhibits a holding time of 100 seconds or longer, more preferably 200 seconds or longer, even more preferably 300 seconds or longer, or particularly preferably 600 seconds or longer (e.g., 900 seconds or longer).

In addition to the property (A), the surface protection sheet according to a preferable embodiment satisfies the following property (B): in the adhesive transfer resistance test carried out based on the procedure described later in Example 1, the surface area left with adhesive transfers is less than 30% (more preferably less than 20%, yet more preferably less than 10%). A surface protection sheet that satisfies the properties (A) and (B) at the same time is preferable because it may produce higher performance. Such a surface protection sheet is preferable as a surface protection sheet used for protecting articles having paint films, for instance, an automobile paint-film protection sheet which is adhered to exterior paint films of automobile bodies.

In general, with a PSA layer having a thickness smaller than 10 μm, in comparison with a PSA layer having a thickness of 10 μm or larger (e.g., about 10 μm to 20 μm), it becomes significantly more difficult to achieve well-balanced high levels of several adhesive properties. Thus, in a conventional surface protection sheet (e.g., automobile paint-film protection sheets), for instance, in order to combine great initial adhesiveness and high adhesive transfer resistance, the PSA layer has commonly had a thickness of 10 μm or larger. According to a preferable embodiment of the surface protection sheet disclosed herein, great initial adhesiveness and high adhesive transfer resistance can be achieved at the same time in spite of that the thickness of the PSA layer is smaller than 10 μm. For instance, can be obtained a surface protection sheet that satisfies the properties (A) and (B) at the same time.

### [Support Substrate]

As the support substrate of the surface protection sheet disclosed herein, can be used a resin film, paper, fabric, a rubber sheet, a foam sheet, metal foil, a composite of these, or the like. Examples of resin films include films of polyolefins (polyethylene, polypropylene, ethylene-propylene copolymers, etc.), polyester films, vinyl chloride resin films, vinyl acetate resin films, polyimide resin films, polyamide resin films, fluorinated resin films, cellophane, and the like. Examples of paper include Washi paper, kraft paper, glassine paper, high grade paper, synthetic paper, top-coated paper and the like. Examples of fabrics include woven fabrics and non-woven fabrics, etc., of a single species or a blend of various fibrous substances. Examples of fibrous substances include cotton, staple fiber, Manila hemp, pulp, rayon, acetate fibers, polyester fibers, polyvinyl alcohol fibers, polyamide fibers, polyolefin fibers, and the like. Examples of rubber sheets include natural rubber sheets, butyl rubber sheets, and the like. Examples of foam sheets include polyurethane foam sheets, polychloroprene foam sheets, and the like. Examples of metal foil include aluminum foil, copper foil, and the like.

The art disclosed herein can be applied preferably to a surface protection sheet using as its support substrate a resin sheet primarily comprising a resin component such as polyolefin, polyester (e.g., polyethylene terephthalate (PET)), or the like. The “resin sheet” herein may typically be a resin film obtainable by molding a resin composition primarily comprising the resin component into a film. The resin sheet may typically be a non-porous resin film. The “non-porous resin film” referred to herein should be conceptually distinguished from the so-called non-woven fabric (i.e., it excludes non-woven fabrics). An especially preferable application may be a surface protection sheet wherein the primary component among resin components constituting the support substrate is a polyolefin-based resin. In other words, such a surface protection sheet preferably comprises a polyolefin-based resin sheet as the support substrate. A support substrate having such a composition is preferable from the standpoint of the recyclability and so on. Preferable examples of the polyolefin-based resin sheet include a resin sheet primarily comprising a polypropylene resin, a low-density polyethylene resin or a linear low-density polyethylene resin. For example, can be preferably used a polyolefin-based resin sheet of which 50% by mass or more is a polyethylene (PE) resin or a polypropylene (PP) resin. In other words, the total amount of PE and PP resins combined accounts for 50% by mass or more of the entire support substrate.

As the polyolefin-based resin sheet, can be preferably used a resin sheet wherein the resin component constituting the sheet primarily comprises a PP resin (or “a PP resin sheet” hereinafter). The polyolefin-based resin typically refers to a resin sheet in which the resin component comprises a PP resin at a ratio higher than 50% by mass. In a preferable resin sheet, for example, the resin component comprises a PP resin at about 60% by mass or higher (more preferably about 70% by mass or higher). The resin sheet may consist essentially of one, two or more species of PP resins as the resin component. In other words, it may be a resin sheet comprising a PP resin solely as the resin component, or, for instance, a resin sheet in which the other resin components besides the PP resin account for less than 1% by mass of all the resin components.

From the standpoint of the heat resistance etc., can be preferably used a resin sheet comprising a continuous phase (continuous constitution) of a PP resin. A surface protection sheet using a resin sheet having such a continuous PP resin phase as the support substrate is preferable because, for instance, the surface protection sheet can be readily prevented from coming off the adherend (e.g., automobile paint films) due to a thermal history such as an elevated temperature, etc., while being aged outside.

The support substrate may have a single-layer structure, or a layered structure with two or more layers. When it has a layered structure, it is preferable that at least one layer comprises a continuous PP resin phase. The remainder of the resin component can be a polyolefin resin (e.g., a PE resin) primarily comprising an olefin-based polymer formed from ethylene or an α-olefin having four or more carbon atoms as the primary monomer, or a resin other than a polyolefin-based resin. An example of a resin sheet that can be preferably used as the support substrate of the surface protection sheet disclosed herein is a polyolefin-based resin sheet wherein the resin component consists essentially of a PP resin and a PE resin. Such a polyolefin-based resin sheet may typically be a PP resin sheet wherein the primary component of the resin component is a PP resin and the remainder is a PE resin.

The primary component of the PP resin can be a polymer (a propylene-based polymer) of various types that contains propylene as a constituent. It can be a PP resin consisting essentially of one, two or more species of propylene-based polymer. The concept of the propylene-based polymer referred to herein include, for instance, the following polypropylenes:

Propylene homopolymers (homopolypropylenes) such as isotactic polypropylenes.

Random copolymers (random polypropylenes) of propylene and other α-olefin(s) (typically, one, two or more species selected from ethylene and α-olefins having 4 to 10 carbon atoms); preferably random polypropylenes constituted with propylene as the primary monomer (a main monomer, i.e., a component accounting for 50% by mass or more of all monomers); for instance, a random polypropylene obtained by random copolymerization of 96 to 99.9 mol % of propylene and 0.1 to 4 mol % of another α-olefin (preferably ethylene and/or butene).

Block copolymers (block polypropylenes) comprising a copolymer (preferably a copolymer wherein the primary monomer is propylene) obtained by block copolymerization of propylene and other α-olefin(s) (typically, one, two or more species selected from ethylene and α-olefins having 4 to 10 carbon atoms), and typically, further comprising as a by-product of the block copolymerization a rubber component formed of at least either one of propylene and the other α-olefin; for instance, a block polypropylene comprising a polymer obtained by block copolymerization of 90 to 99.9 mol % of propylene and 0.1 to 10 mol % of other α-olefin(s) (preferably ethylene and/or butene), and further comprising as a by-product a rubber component formed of at least either one of propylene and the other α-olefin.

The PP resin can be formed essentially of one, two or more species of such propylene-based polymer, or can be a thermoplastic olefin resin (TPO) or a thermoplastic elastomer (TPE) of a reactor blend type obtainable by copolymerizing a propylene-based polymer with a large amount of a rubber component, or of a dry blend type obtainable by mechanically dispersing the rubber component in a propylene-based polymer. Alternatively, it can be a PP resin comprising a copolymer of propylene and other monomer(s) (functional monomer) containing other functional group(s) in addition to a polymerizing functional group, a PP resin obtained by copolymerizing such a functional monomer with a propylene-based polymer, or the like.

The primary component of the PE resin can be a polymer (an ethylene-based polymer) of various types that contains ethylene as a constituent. It can be a PE resin consisting essentially of one, two or more species of ethylene-based polymer. The ethylene-based polymer can be an ethylene homopolymer or a product of copolymerization (random copolymerization, block copolymerization, etc.) of ethylene as the primary monomer and other α-olefin(s) as a secondary monomer. Preferable examples of the α-olefin include α-olefins having 3 to 10 carbon atoms such as propylene, 1-butene (which can be a branched 1-butene), 1-hexene, 4-methyl-1-pentene, 1-octene, and the like. For instance, a preferable PE resin comprises primarily an ethylene-based polymer in which the α-olefin(s) as the secondary monomer is copolymerized up to 10% by mass (typically up to 5% by mass) with ethylene as the primary monomer.

It can be a PE resin comprising a copolymer of ethylene and a monomer (functional monomer) containing other functional group(s) in addition to a polymerizing functional group, a PE resin obtained by copolymerizing such a functional monomer with an ethylene-based polymer, or the like. Examples of a copolymer of ethylene and a functional monomer include ethylene-vinyl acetate copolymers (EVA), ethylene-acrylic acid copolymers (EAA), ethylene-methacrylic acid copolymers (EMAA), ethylene-methyl acrylate copolymers (EMA), ethylene-ethyl acrylate copolymers (EEA), ethylene-methyl methacrylate copolymers (EMMA), ethylene-(meth)acrylic acid (i.e., ethylene-acrylic acid, or ethylene-methacrylic acid) copolymers crosslinked by metal ions, and the like.

The density of the PE resin is not particularly limited, and it can be, for instance, about 0.9 g/cm³ to 0.94 g/cm³. Preferable PE resins include low-density polyethylene (LDPE) and linear low-density polyethylene (LLDPE). The PE resin may comprise one, two or more species of LDPE and one, two or more species of LLDPE. There are no particular limitations on the proportions of the respective LDPEs or LLDPEs, or the blend ratio of LDPE to LLDPE, and they can be suitably selected so as to obtain a PE resin that exhibits desirable properties.

Although not particularly limited, as the resin material constituting the support substrate, can be preferably used a resin material having a MFR (melt flow rate) of approximately 0.5 g/10 min to 80 g/10 min (e.g., 0.5 g/10 min to 10 g/10 min). Herein, the MFR refers to a value measured by method A at a temperature of 230° C. and an applied load of 21.18 N based on JIS K 7210. The resin material can be a polyolefin-based resin (e.g., a PP resin, a PE resin, a blend resin of a PP resin and a PE resin, or the like) having a MFR in the said range.

The resin sheet (preferably a polyolefin-based resin sheet) used as a support substrate of the surface protection sheet disclosed herein may contain as necessary suitable components allowed for inclusion in the substrate in accordance with desired properties such as light-blocking ability, weatherability, heat resistance, consistent coating, adhesive properties, and so on. For example, it may suitably contain additives such as pigments (typically inorganic pigments), fillers, antioxidants, photo-stabilizing agents (meaning to include radical scavengers, UV (ultraviolet rays)—absorbing agents, etc.), slipping agent, anti-blocking agent, and so on. Examples of materials that can be preferably used as pigments or fillers include inorganic powders such as titanium oxide, zinc oxide, calcium carbonate, and the like. The amount of an inorganic pigment or a filler can be suitably selected in consideration of the extent of the effects produced by the additive and the substrate moldability suitable for the method (casting, inflation molding, etc.) employed for forming the resin sheet. It is usually preferable that the amount of a pigment or a filler (when several species are added, their combined amount) is about 2 to 20 parts by mass (more preferably about 5 to 15 parts by mass) relative to 100 parts by mass of the resin component. For example, each additive can be added in an amount equal to that is normally employed in the field of resin sheets used as support substrates in surface protection sheets (e.g., automobile paint-film protection sheets).

The resin sheet (preferably a polyolefin-based resin sheet) can be produced by employing a suitable film formation method heretofore known. For example, can be preferably employed a method that involves extrusion of a molding material containing the resin component (preferably, a resin component consisting of a PP resin solely, or a resin comprising a PP resin as the primary component and a PE resin as a secondary component) and additives, etc., added as necessary.

In a support substrate 1 (typically a resin sheet) shown in FIG. 1, a face (front face) 1A to which a PSA layer 2 is to be provided can be pre-subjected to a surface treatment such as an acid treatment, corona discharge treatment, UV irradiation, plasma treatment, or the like. In the support substrate 1, a face (back face) 1B opposite to the face to which the PSA layer 2 is to be provided can be pre-subjected as necessary to a release treatment. In such a release treatment, for example, a release agent based on silicone, a long-chain alkyl, or fluorine, etc., is applied to form a film having a thickness of typically about 0.01 μm to 1 μm (e.g., 0.01 μm to 0.1 μm). Such a release treatment can produce effects such as easy unwinding of the surface protection sheet 10 wound in a roll, etc.

The thickness of the support substrate is not particularly limited and can be suitably selected according to the intended purpose. It is usually suitable to use a support substrate having a thickness of about 300 μm or smaller (e.g., about 10 μm to 200 μm). In a preferable embodiment of the surface protection sheet disclosed herein, the support substrate has a thickness of about 10 μm to 100 μm (more preferably about 20 μm to 60 μm, e.g., about 20 μm to 50 μm). For instance, a surface protection sheet using a support substrate having such a thickness is preferable as an automobile paint-film protection sheet.

As the support substrate in the art disclosed herein, can be used a support substrate having a mass per unit area of 60 g/m² or less. That is, a preferable support substrate has a grammage of 60 g/m² or less. Such a support substrate is suitable for constituting a surface protection sheet having a small mass per unit area (i.e., being lightweight) with a small thickness of a PSA layer. A surface protection sheet having a small mass per unit area is preferable since it can provide a roll body comprising the surface protection sheet with excellent handling properties or it can provide great workability of applying the surface protection sheet to adherends. From such standpoints, it is more preferable to use a support substrate having a grammage of 50 g/m² or less, or even more preferably 45 g/m² or less (e.g., 40 g/m² or less). While the lower limit of the mass of the support substrate is not particularly limited, it is usually preferable to use a support substrate having a grammage of 10 g/m² or greater, or more preferably 15 g/m² or greater (e.g., 20 g/m² or greater).

The support substrate of the surface protection sheet disclosed herein preferably has an average light transmittance of 20% or lower (more preferably 10% or lower, even more preferably 5% or lower, e.g., 2% or lower) in a wavelength range of 300 nm to 350 nm. A support substrate having such an average light transmittance exhibits a great ability to block light (UV rays) in the said wavelength range. Thus, according to a surface protection sheet comprising such a support substrate, UV degradation of the PSA layer in the surface protection sheet can be effectively suppressed. This is especially meaningful in applications where the surface protection sheet is subjected to long-term outside storage in a state of being adhered to an adherend, such as of automobile paint-film protection sheets.

The average light transmittance in the said wavelength range can be measured based on HS K7361, using a commercial system. In particular, for instance, it can be measured in accordance with the method for measuring light transmittance described later in Example 1.

The average light transmittance of the support substrate can be suitably adjusted, for instance, by modifying the composition or the thickness of the support substrate. For example, inclusion of a weathering stabilizer such as pigments, fillers, antioxidants, photo-stabilizing agents (meaning to include radical scavengers, UV-absorbing agents, etc.), etc., can lower the average light transmittance in the said wavelength range. As the pigments, can be preferably used highly weathering resistant inorganic powder (typically a metal oxide) such as titanium oxide, zinc oxide, and the like. As the support substrate in the art disclosed herein, can be preferably used a support substrate provided with such a weathering resistant formulation, that is, a formulation that lowers the average light transmittance in the said wavelength range. For example, it is preferable to use a polyolefin-based resin sheet provide with such a weathering resistant formulation.

### [PSA Layer]

### <Base Polymer>

The PSA constituting the PSA layer contained in the surface protection sheet disclosed herein can be, for instance, various known PSAs such as rubber-based PSA (meaning to include natural rubber-based PSA, synthetic rubber-based PSA, PSA formed of a mixture of these, etc.), acrylic PSA, silicone-based PSA, polyester-based PSA, urethane-based PSA, polyether-based PSA, polyamide-based PSA, fluorine-based PSA, and the like. Herein, the term “rubber-based PSA” refers to a PSA comprising a rubber-based polymer as the base polymer. The same applies to acrylic PSA and other PSAs. In the present description, a base polymer of a PSA refers to a component accounting for the largest portion of the polymeric components contained in the PSA (which may be a component accounting for the entire polymeric components). The base polymer is usually a component that accounts for more than 50% by mass (e.g., 70% by mass or greater) of the polymeric components contained in the PSA.

In the surface protection sheet according to a preferable embodiment, the PSA layer is a rubber-based PSA layer formed from a PSA composition comprising a rubber-based polymer as the base polymer. Examples of rubber-based polymers include various rubber-based polymers such as natural rubbers; styrene-butadiene rubbers (SBR); polyisoprene; butene-based polymers comprising a butene (including 1-butene, cis- or trans-2-butene, and 2-methylpropane (isobutylene)) as a primary monomer; ABA-type block copolymer rubbers and hydrogenation products thereof, for example, styrene-butadiene-styrene block copolymer rubbers (SBS), styrene-isoprene-styrene block copolymer rubbers (SIS), styrene-isobutylene-styrene block copolymer rubbers (SIBS), styrene-(vinyl isoprene)-styrene block copolymer rubbers (SVIS), styrene-ethylene-butylene-styrene block copolymer rubbers (SEBS) which are hydrogenation products of SBS, styrene-ethylene-propylene-styrene block copolymer rubbers (SEPS) which are hydrogenation products of SIS; and the like. Preferable examples of the butene-based polymer include isobutylene-based polymers. Specific examples of the isobutylene-based polymer include polyisobutylene, copolymers of isobutylene and isoprene, and the like.

In a preferable embodiment of the surface protection sheet disclosed herein, the PSA layer comprises 5% by mass or more of an isobutylene group represented by the formula (I). A PSA layer having such a composition is likely to exhibit a stable peel strength. It is preferable because, for instance, after adhered to an adherend, an excessive increase in the peel strength due to aging or a thermal history can be readily suppressed. A non-crosslinked PSA can exhibit desirable adhesive properties; and therefore, it is unlikely to cause stress (strain) to an adherend surface. Thus, even if it is adhered to an adherend having a paint film such as an automobile body, etc., the surface protection sheet is unlikely to leave adhesion marks to the paint film, making the said PSA layer preferable. Preferable examples of a PSA layer containing 5% by mass or more of an isobutylene group include a PSA layer containing an isobutylene-based polymer as the primary component, a PSA layer containing a block copolymer (e.g., SIBS) comprising an isobutylene block as the primary component, and the like. The PSA layer contains an isobutylene group preferably in an amount of preferably 15% by mass or greater, more preferably 30% by mass or greater, or even more preferably 50% by mass or greater (e.g., 70% by mass or greater).

The art disclosed herein can be applied preferably to a surface protection sheet in which the PSA layer comprises primarily a non-crosslinked polymer. For instance, it can be practiced in an embodiment of a surface protection sheet comprising a PSA layer formed from a PSA (a non-crosslink-type PSA) wherein the base polymer is not crosslinked. Herein, the term “PSA layer formed from a non-crosslink-type PSA” refers to a PSA layer that has not been purposely subjected to a treatment (i.e., a crosslinking treatment, e.g., addition of a crosslinking agent, etc.) to form chemical bonds among base polymers during formation of the PSA layer. Such a PSA layer is essentially non-susceptible to accumulation of strain (even if a temporal strain is generated, the strain can be readily dissipated), being less likely to cause stress to the adherend surface. This is especially meaningful when the PSA layer has a small thickness, such as in the surface protection sheet disclosed herein. This is because as compared to a thicker PSA layer, a thin PSA layer (e.g., a PSA layer having a thickness smaller than 10 μm) has a poorer capability to dissipate stress within itself, whereby a strain in the PSA layer is likely to promptly cause stress to adherend surfaces. A PSA layer formed from a non-crosslink-type PSA has properties preferable as a PSA layer in a surface protection sheet, such that it is less likely to cause stress to adherend surfaces in spite of its small thickness.

In a preferable non-crosslink-type PSA, the base polymer is a rubber-based polymer. Examples include a PSA comprising an ABA-type block copolymer rubber as described earlier or its hydrogenation product as the base polymer, a PSA comprising an isobutylene-based polymer as the base polymer, and the like. Among these, a preferable PSA layer is constituted with a PSA (a polyisobutylene-based PSA) formed from a PSA composition comprising an isobutylene-based polymer as the base polymer. Such a PSA layer is highly elastic and is preferable as a PSA (removable PSA) for use in a PSA sheet used in an embodiment where it is eventually removed such as a surface protection sheet. A PSA layer formed from the polyisobutylene-based PSA generally yields a large difference in the solubility parameter (SP value) relative to paint films (e.g., automobile paint films); and therefore, migration of substances is unlikely to occur between the two, and being a non-crosslink-type, it is unlikely to leave adhesion marks on paint films. Thus, the surface protection sheet comprising such a PSA layer is preferable as a paint film-protective sheet (e.g., an automobile paint-film protection sheet).

In a preferable embodiment of the surface protection sheet disclosed herein, among the polymeric components in the PSA, greater than 50% by mass (e.g., 70% by mass or greater, or even 85% by mass or greater) is an isobutylene-based polymer. The PSA may be essentially free of a polymeric component other than an isobutylene-based polymer. In such a PSA, for instance, the proportion of polymers other than an isobutylene-based polymer may be 1% by mass or less of the polymeric components, or it may be below detection limits.

In the present description, the “isobutylene-based polymer” is not limited to homopolyisobutylenes (homopolymers of isobutylene), but the concept thereof encompasses even copolymers comprising isobutylene as the primary monomer. Such copolymers include a copolymer in which isobutylene accounts for the largest amount among the monomers constituting the isobutylene-based polymer. In typical, it may be a copolymer in which isobutylene accounts for greater than 50% by mass or even 70% by mass or greater of the monomers. Examples of the copolymer include copolymers of isobutylene and normal butylene, copolymers of isobutylene and isoprene, vulcanized or modified products of these, and the like. Examples of such copolymers include butyl rubbers such as regular butyl rubbers, chlorinated butyl rubbers, brominated butyl rubbers, partially crosslinked butyl rubbers and the like. Examples of the vulcanized or modified products include those modified with functional groups such as hydroxyl group, carboxyl group, amino group, epoxy group, and the like. From the standpoint of the stability of adhesive strength (e.g., a property that suppresses an excessive increase in the adhesive strength due to aging or a thermal history), preferably usable isobutylene-based polymers may include homopolyisobutylenes, copolymers of isobutylene and normal butylene, and the like. Such a copolymer may be, for example, an isobutylene/normal butylene copolymer, with the copolymerization ratio of normal butylene being smaller than 30 mol %.

Preferable examples of the isobutylene-based polymer in the art disclosed herein include polyisobutylenes. In the present description, polyisobutylene is a polymer comprising monomers other than isobutylene at a copolymerization ratio of 10% by mass or smaller (preferably 5% by mass or smaller). In particular, homopolyisobutylenes are preferable.

The molecular weight of the isobutylene-based polymer (typically a polyisobutylene) is not particularly limited. For instance, an isobutylene-based polymer having a weight average molecular weight (Mw) of about 10×10⁴ to 150×10⁴ can be suitably selected and used. Two or more isobutylene-based polymers having individually different Mw values may be used in combination. The isobutylene-based polymer used as the base polymer as a whole preferably has a Mw value in a range of about 20×10⁴ to 150×10⁴ (more preferably about 30×10⁴ to 100×10⁴).

The isobutylene-based polymer (typically a polyisobutylene) may have a number average molecular weight (Mn) of about 10×10⁴ to 40×10⁴. Two or more isobutylene-based polymers having individually different Mn values may be used in combination. The isobutylene-based polymer used as the base polymer as a whole preferably has a Mn value in a range of about 10×10⁴ to 40×10⁴ (more preferably about 12×10⁴ to 30×10⁴).

When the Mw or Mn value is far above the range given above, the solution viscosity of the PSA may turn out too high, giving rise to a tendency for the PSA solution to exhibit poorer handling properties (e.g., coating consistency). When the Mw or Mn value is far below the range given above, the cohesive strength of the PSA may tend to turn out insufficient and may be likely to produce adhesive transfers if used under demanding conditions (e.g., when adhered to a paint film having minute unevenness on the surface, such as paint films of vehicles resurfaced by polishing).

Part or all of the isobutylene-based polymer may be an isobutylene-based polymer (a masticated product) obtained from an isobutylene-based polymer with a higher molecular weight via a mastication process to lower the molecular weight (preferably to lower the weight average molecular weight to the preferable range described above). The mastication process can be preferably carried out so as to obtain an isobutylene-based polymer having a Mw value equal to approximately 10% to 80% of the pre-mastication value. It is also preferable to carry out the process so as to obtain an isobutylene-based polymer having a number average molecular weight (Mn) of about 10×10⁴ to 40×10⁴. Such a mastication process can be performed based on the contents of Japanese Patent No. 3878700.

The Mw and Mn values herein refer to the values calibrated with polystyrene standard, which can be determined based on gel permeation chromatography (GPC) analyses. As a GPC system, can be used, for instance, model number “HLC-8120GPC” available from Tosoh Corporation.

A preferable base polymer (e.g., an isobutylene-based polymer, typically a polyisobutylene) comprises two or more different polymer species having different molecular weight distributions. Herein, having different molecular weight distributions means that elution peaks in their GPC spectra have different elution times and/or shapes. According to a PSA having such a composition, by modifying the selection of the two or more different polymer species and their relative amounts, at least one (preferably both) of the dispersion degree (Mw/Mn) and the viscosity of the PSA can be readily adjusted to be in the preferable range disclosed herein while having Mw and Mn values in prescribed ranges. It is preferable that as the base polymer, two or more different polymer species having different Mw values are contained. The presence of two or more different polymer species having different Mw values can be confirmed, for example, with a molecular weight distribution having two or more elusion peaks with maxima at different elusion times (i.e., being bi-modal (double-peaked), or triple or more-peaked)) in the GPC analysis. It is noted that each of the two or more different polymer species typically exhibits a uni-modal (single-peaked) molecular weight distribution.

As the two or more different polymer species having different Mw values, can be used, for instance, a suitable combination of polymers having a Mw value in a range of 1×10⁴ to 130×10⁴. It is preferable to select the two or more different polymer species so that the polymer with the highest molecular weight has a Mw value five or more times (e.g., 5 to 20 times, typically about 8 to 12 times) the Mw value of the polymer with the lowest molecular weight. The dispersion degree (Mw/Mn) of each polymer is preferably, for example, 1.5 or larger (more preferably 2 or larger, e.g., 2 to 5).

In a preferable embodiment, the base polymer comprises at least one species of higher molecular weight polymer P_{H} having a Mw value in a range of 70×10⁴ to 130×10⁴ (preferably 70×10⁴ to 120×10⁴, e.g., 70×10⁴ to 100×10⁴) and at least one species of lower molecular weight polymer P_{L} having a Mw value in a range of 3×10⁴ to 20×10⁴ (typically 4×10⁴ to 10×10⁴). A preferable higher molecular weight polymer P_{H} may have a dispersion degree (Mw/Mn) of 2 to 5. A preferable lower molecular weight polymer P_{L} may have a dispersion degree (Mw/Mn) of 1.5 to 3.5. The base polymer may further comprise a polymer having a Mw value somewhere intermediate between those of the P_{H} and P_{L}. The total amount of the P_{H} and P_{L} preferably accounts for 70% by mass or greater (e.g., 80% by mass or greater, typically 90% by mass or greater) of the base polymer as a whole. The base polymer of the PSA may consist essentially of a P_{H} and a P_{L}.

The ratio of the two or more different polymer species can be suitably selected so as to produce a preferable molecular weight distribution (Mw and Mn values, preferably even the dispersion degree) or a preferable viscosity value disclosed herein. For example, the P_{H}-to-P_{L} mass ratio (P_{H}/P_{L}) is preferably 95/5 to 50/50 (e.g., 95/5 to 70/30, typically 90/10 to 75/25). In order to produce higher adhesive transfer resistance, it is preferable to form the composition such that the P_{H} accounts for 60% by mass or greater (typically 60 to 95% by mass, e.g., 70 to 95% by mass) of the base polymer as a whole. In a preferable embodiment, each of the P_{H} and P_{L} is an isobutylene-based polymer (typically a polyisobutylene).

### <Tackifier Resin>

The PSA can comprise a tackifier resin as necessary. Examples of preferable tackifier resins include rosin-based resins, terpene-based resins, petroleum resins, phenol resins, alkylphenol resins, xylene resins, coumarone-indene resins, alkyd resins, epoxy resins, hydrogenation products of these, and the like. Among these tackifier resins, can be used one species solely or a suitable combination of two or more species.

Examples of the rosin-based resin include unmodified rosins (raw rosins) such as gum rosin, wood rosin, tall-oil rosin, etc.; modified rosins (hydrogenated rosins, disproportionated rosins, polymerized rosins, other chemically-modified rosins, etc.) obtainable from the unmodified rosins via modifications such as hydrogenation, disproportionation, polymerization, etc.; various other rosin derivatives; and the like.

Examples of the rosin derivatives include rosin esters such as compounds obtainable from unmodified rosins via esterification with alcohols (i.e., esterification products of unmodified rosins), compounds obtainable from modified rosins (hydrogenated rosins, disproportionated rosins, polymerized rosins, etc.) via esterification with alcohols (i.e., esterification products of modified rosins), etc.; unsaturated fatty-acid-modified rosins obtainable from unmodified rosins or modified rosins (hydrogenated rosins, disproportionated rosins, polymerized rosins, etc.) via modifications with unsaturated fatty acids; unsaturated fatty-acid-modified rosin esters obtainable from rosin esters via modifications with unsaturated fatty acids; rosin alcohols obtainable via reduction of carboxyl groups from unmodified rosins, modified rosins (hydrogenated rosins, disproportionated rosins, polymerized rosin, etc.), unsaturated fatty-acid-modified rosins and unsaturated fatty-acid-modified rosin esters; metal salts of rosins (particularly rosin esters) such as unmodified rosins, modified rosins, various rosin derivatives, etc.; rosin phenol resins obtainable from rosins (unmodified rosins, modified rosins, various rosin derivatives, etc.) via addition of phenol in the presence of an acid catalyst followed by thermal polymerization; and so on.

Examples of the terpene-based tackifier resins include terpene resins (or “unmodified terpene resins” hereinafter so as to clearly distinguish these from modified terpene resins described next) such as α-pinene polymers, β-pinene polymers, dipentene polymers, etc.; modified terpene resins obtainable from terpenes or terpene resins via modifications (e.g., phenol modification, styrene modification, hydrogenation, hydrocarbon modification, and so on); and so on. Examples of the modified terpene resins include terpene-phenol resins, styrene-modified terpene resins, hydrogenated terpene resins, and so on.

The term “terpene-phenol resin” refers to a polymer containing terpene residue and phenol residue, and the scope thereof encompasses both a terpene-phenol copolymer resin (a copolymer of a terpene and a phenolic compound) and a phenol-modified terpene resin (a phenol-modification product of a terpene homopolymer or a terpene copolymer (a terpene resin, typically an unmodified terpene resin)). Preferable examples of the terpene in the terpene-phenol resin include mono-terpenes such as α-pinene, β-pinene, limonene (including d-limonene, l-limonene, and d/l-limonene (dipentene)), and the like.

The surface protection sheet disclosed herein preferably exhibits practically favorable levels of non-contaminating properties in addition to great initial adhesiveness. Herein, non-contaminating properties of a surface protection sheet refer to properties that allow its removal after use as a protective means without leaving residues of the surface protection sheet on the adherend surface (i.e., without contaminating the adherend surface with residues from the surface protection sheet).

A tackifier resin has a weight average molecular weight (Mw) of preferably 300 or larger (more preferably 400 or larger, even more preferably 500 or larger, e.g., 1000 or larger). A tackifier resin has a weight average molecular weight (Mw) of preferably 3×10⁴ or smaller (more preferably 0.5×10⁴ or smaller). By this, can be obtained great adhesive strength to adherends.

### <Tackifier Resin (Tₕₛ) Having an SP Value of 8.5 or Larger>

In a preferable embodiment of the art disclosed herein, the PSA comprises a tackifier resin (Tₕₛ) having an SP value (in (cal/cm³)^{1/2}, the same applies hereinafter) of 8.5 or larger. As the tackifier resin (Tₕₛ), can be preferably used, for instance, a tackifier resin having an SP value in a range of 8.5 to 15. As the tackifier resin (Tₕₛ) in the art disclosed herein, for example, can be used phenolic compounds, amine-based compounds, rosin-based resins (e.g., unmodified rosins) and the like, all of which have the above-described SP value. For the tackifier resin (Tₕₛ), can be used one species solely or a suitable combination of two or more species.

Herein, the SP value of a compound indicates the solubility of the compound and is a value calculated from the basic structure of the compound by the method suggested by Fedors. In particular, from the vaporization energy, Δe (cal), of each atom or an atomic group at 25° C. as well as the molar volume, Δv (cm³), of the atom or the atomic group at the same temperature, the SP value is calculated according to the next equation:

SP value (δ)=(ΣΔe/ΣΔv)^{1/2}

(Reference document: Hideki Yamamoto, “SP value fundamentals, application, and calculation method”, 4th edition, published by Johokiko Co., Ltd., Apr. 3, 2006, pp. 66-67).

According to such a tackifier resin (Tₕₛ), addition of a small amount can effectively increase the adhesive properties (e.g., the adhesive strength relative to a hard-to-adhere paint film). Thus, the art disclosed herein can be practiced preferably in an embodiment where the tackifier resin (Tₕₛ) content in the PSA is 0.01 to 5 parts by mass (preferably 0.01 to 1.0 part by mass) relative to 100 parts by mass of the base polymer. Herein, hard-to-adhere paint film refers to, for example, a paint film on which n-hexadecane results in a contact angle of 15° or larger. The contact angle can be determined by procedures including: while keeping the paint film horizontal, an approximately 2 μL droplet of n-hexadecane is dropped on top of the paint film under an atmosphere at 23° C. and 65% RH, and the angle formed by the tangent line of the droplet and the paint film surface is measured within one minute after the deposition of the droplet.

The tackifier resin (Tₕₛ) having such an SP value presumably allows atypical miscible phases to form locally around the interface between the PSA and the adherend (e.g., hard-to-adhere paint films of automobiles), contributing to increase the adhesive strength to the adherend. Such effects can be produced especially well, for instance, when the base polymer of the PSA is a rubber-based polymer (typically, a non-crosslinked isobutylene-based polymer, e.g., a polyisobutylene). From the standpoint of the formation of the miscible phases and the capability to increase the adhesive strength, it is usually preferable to use a tackifier resin (Tₕₛ) having a weight average molecular weight (Mw) of 300 or larger (more preferably 400 or larger, even more preferably 500 or larger, e.g., 1000 or larger). A preferable tackifier resin (Tₕₛ) has a Mw value of 3×10⁴ or smaller (more preferably 0.5×10⁴ or smaller).

Preferable examples of a phenol-based compound that can be used as the tackifier resin (Tₕₛ) may include phenol resins, alkylphenol resins, rosin-modified phenol-based resins and terpene-modified phenol resins. As the alkylphenol resin, can be preferably used an alkylphenol resin having a side chain alkyl group with 3 or more carbon atoms (typically an alkyl group having 3 to 18 carbon atoms, e.g., 5 to 12), such as tert-butylphenol resins, tert-amylphenol resins, tert-octylphenol resins, and the like.

Preferable examples of the tackifier resin (Tₕₛ) used for the PSA in the art disclosed herein can include phenol-based compounds having an SP value of 9.5 or larger (typically 9.5 to 15, e.g., 10 to 15). Examples of such a phenol-based compound include trade name “DUREZ 19900” available from Sumitomo Durez Co., Ltd.

The tackifier resin (Tₕₛ) is typically a material not intended for absorbing UV rays or for trapping or stabilizing radicals when photo-degradation reactions occur within the system containing the resin. Thus, a material generally used as an antioxidant or a photo-stabilizing agent shall be distinguished from the tackifier resin (Tₕₛ) referred to herein.

The tackifier resin (Tₕₛ) may have a softening point of 120° C. or above, or it can be below 120° C. From the standpoint of the non-contaminating properties, etc., a preferable tackifier resin (Tₕₛ) has a softening point of, for instance, 40° C. or above (more preferably 60° C. or above).

When the PSA comprises a tackifier resin (Tₕₛ) having a high SP value, the mass ratio of the tackifier resin (Tₕₛ) contained in the total mass of the PSA can be, for instance, greater than zero % by mass, but 5.0% by mass or less. It is usually suitable to be 0.05 to 5.0% by mass (preferably 0.05 to 1.0% by mass, typically 0.1% by mass or greater, but less than 1.0% by mass). It is usually suitable that when the PSA comprises a tackifier resin (Tₕₛ) having a high SP value, its content is 5 parts by mass or less (e.g., 2.5 parts by mass or less) relative to 100 parts by mass of the base polymer. From the standpoint of the non-contaminating properties, it is advantageous that the tackifier resin (Tₕₛ) content is 1.0 part by mass or less (typically 0.01 to 1.0 part by mass) relative to 100 parts by mass of the base polymer. The art disclosed herein can be practiced preferably in an embodiment where the tackifier resin (Tₕₛ) content in the PSA is 0.8 part by mass or less (more preferably 0.5 part by mass or less, e.g., 0.01 to 0.4 part by mass) relative to 100 parts by mass of the base polymer.

### <Other Additives>

The PSA used in the surface protection sheet disclosed herein may contain as necessary suitable components (additives) allowable for inclusion in the PSA, besides the base polymer and the tackifier resins used as necessary. Examples of such additives include softeners, release agents, pigments, fillers, antioxidant, light-stabilizing agents (meaning to include radical scavengers, UV absorbers, etc.) and the like. Examples of a softener include rubber-based materials having low molecular weights, process oils (typically paraffin-based oils), petroleum-based softeners, epoxy-based compounds, and the like. Examples of a release agent include silicone-based release agents, paraffin-based release agents, polyethylene wax, acrylic polymers and the like. When using a release agent, its amount can be, for instance, about 0.01 to 5 parts by mass relative to 100 parts by mass of the base polymer. Alternatively, the PSA may have a composition essentially free of such a release agent. Examples of pigments and fillers include inorganic powders such as titanium oxide, zinc oxide, calcium oxide, magnesium oxide, silica and the like.

Each of these additives can be used solely as a single species or in a combination of two or more species. Each additive can be used in an amount usually employed in the field of the PSA used for surface protection sheets (e.g., automobile paint-film protection sheets). The total amount of the tackifier resin and other additives combined is preferably 30 parts by mass or less (more preferably 15 parts by mass or less, e.g., 5 parts by mass or less) relative to 100 parts by mass of the base polymer.

### <Formation Method of PSA Layer>

The PSA layer can be formed based on a method for forming PSA layers known in the PSA sheet field. For instance, can be preferably employed a method (direct method) where a PSA layer is formed by directly providing (typically applying) a PSA composition to a support substrate and allowing the composition to dry, with the PSA composition being obtainable by dissolving or dispersing in a suitable solvent a PSA-layer-forming material mixture comprising a polymeric component and additives added as necessary. Alternatively, can be employed a method (transfer method) where a PSA layer is transferred to a support substrate, with the PSA layer having being pre-formed on a highly releasable surface (e.g., a release liner surface, the back face of a support substrate that has been processed with a release treatment, etc.) by applying the PSA composition thereto and allowing the composition to dry. The PSA composition can be applied, for instance, using a known or commonly used coater such as a gravure roll coater, reverse roll coater, kiss roll coater, dip roll coater, bar coater, knife coater, spray coater, or the like. From the standpoint of facilitating the crosslinking reaction and increasing the production efficiency, etc., it is preferable to allow the PSA composition to dry with heating. It is usually preferable that the drying temperature is set, for example, around 40° C. to 120° C. While the PSA layer is typically formed to have a continuous phase, it can be formed to have a regular or random pattern of dots, stripes, etc., depending on the purpose and intended use.

The form of the PSA composition is not particularly limited, and can be, for instance, a PSA composition (a solvent-based PSA composition) containing a PSA (an adhesive component) having such a composition described above in an organic solvent, a PSA composition (water-dispersed PSA composition, typically an aqueous emulsion-based PSA composition) containing a PSA dispersed in an aqueous solvent, a hot-melt PSA composition, or the like. From the standpoint of the ease of application and the latitude in the choice of a substrate, etc., a solvent-based or a water-dispersed PSA composition can be used preferably. For obtaining even greater adhesive properties, a solvent-based PSA composition can be used preferably in particular. Typically, such a solvent-based PSA composition can be prepared as a solution containing the respective components described above in an organic solvent. The organic solvent can be selected among known or commonly used organic solvents. For instance, can be used any one species or a mixture of two or more species among aromatic compounds (typically aromatic hydrocarbons) such as toluene, xylene, etc.; acetic acid esters such as ethyl acetate, butyl acetate, etc.; aliphatic or alicyclic hydrocarbons such as hexane, cyclohexane, heptane, methyl cyclohexane, etc.; halogenated alkanes such as 1,2-dichloroethane, etc.; ketones such as methyl ethyl ketone, acetyl acetone, etc.; and the like. While not particularly limited, it is usually suitable that the solvent-based PSA composition is prepared to have a solid content (NV) of 5 to 30% by mass (e.g., 10 to 25% by mass). Too low an NV tends to result in higher production costs while too high an NV may lower the handling properties such as the ease of application, etc.

The PSA in the art disclosed herein has a viscosity at 30° C. of preferably 10 mPa·s or lower, more preferably 5 mPa·s or lower, or even more preferably 1.5 mPa·s or lower when measured with a toluene solution containing 10% by mass of the PSA. Such a PSA has a low solution viscosity for its solid content (NV), thereby providing good handling properties. This is preferable from the standpoint of increasing the productivity of the surface protection sheet and reducing the solvent usage, etc. While the lower limit of the viscosity is not particularly limited, it is usually preferable to be 0.2 mPa·s or higher (e.g., 0.4 mPa·s or higher). It is noted that while the solution viscosity of the PSA is specified herein based on its 10% by mass toluene solution, the NV of the PSA composition used during the surface protection sheet fabrication (particularly during the PSA layer formation) is not limited to 10% by mass, and the PSA may have a suitable NV (e.g., 5 to 30% by mass, preferably 10 to 25% by mass) in consideration of the coating consistency and the productivity, etc.

In the surface protection sheet disclosed herein, the adhesive face has an arithmetic mean roughness (Ra) of preferably 1.0 μm or smaller (more preferably 0.75 μm or smaller). This is especially meaningful when the PSA layer has a small thickness, such as in the surface protection sheet disclosed herein. This is because as compared to a thicker PSA layer, a thin PSA layer (e.g., a PSA layer having a thickness smaller than 10 μm) has a poorer capability to compensate minute unevenness on the adhesive face through deformation of itself so as to tightly adhere to adherend surfaces, giving rise to a tendency for the roughness on the PSA layer surface to greatly affect the adhesion to adherend surfaces. From such a standpoints, the surface protection sheet has an arithmetic mean roughness (Ra) of preferably 0.70 μm or smaller, or more preferably 0.60 μm or smaller (e.g., 0.50 μm or smaller). The lower limit of the arithmetic mean roughness (Ra) of the adhesive face is not particularly limited. In view of the productivity and costs of the surface protection sheet, it is usually suitable to be 0.10 μm or larger (e.g., 0.20 μm or larger).

Herein, the arithmetic mean roughness (Ra) refers to the arithmetic mean roughness (Ra) of a roughness curve specified in JIS B0601:2001. The arithmetic mean roughness (Ra) of the adhesive face can be measured with a general surface roughness measurement system (e.g., a non-contact three-dimensional surface topography measurement system under model number “Wyko NT-3300” available from Veeco Instruments Inc.). More specifically, for example, it can be measured based on the arithmetic mean roughness measurement described later in Example 1.

The arithmetic mean roughness (Ra) of the adhesive face can be adjusted by modifying, for instance, the conditions under which the PSA composition is applied or allowed to dry, etc. When the PSA layer is formed by the transfer method, the surface to which the PSA composition is applied preferably has an arithmetic mean roughness (Ra) of 1.0 μm or smaller (e.g., 0.75 μm or smaller). The surface (front face 1A in the example shown in FIG. 1) of the support substrate on the side to be provided with a PSA layer has an arithmetic mean roughness (Ra) of preferably 2.0 μm or smaller or more preferably 1.0 μm or smaller (e.g., 0.75 μm or smaller). The other surface (back face 1B in the example shown in FIG. 1) of the support substrate, which is opposite to the side to be provided with a PSA layer, has an arithmetic mean roughness (Ra) of preferably 1.0 μm or smaller or more preferably 0.75 μm or smaller (e.g., 0.50 μm or smaller).

The surface protection sheet disclosed herein may have a mass per unit area of about 80 g/m² or less (e.g., 70 g/m² or less). In a preferable embodiment, the surface protection sheet has a mass per unit area of 60 g/m² or less. In other words, a preferable surface protection sheet has a grammage of 60 g/m² or less. A surface protection sheet having such a small grammage is preferable because, for instance, in an embodiment where the surface protection sheet is wound in a roll and included in a roll body, it allows reduction of the mass of the roll body or inclusion of a longer length of the surface protection sheet in the same mass of the roll body. This is advantageous in view of increasing handling properties of the roll body or the efficiency of applying the surface protection sheet to adherends. From such standpoints, the surface protection sheet has a grammage of preferably 55 g/m² or less or more preferably 50 g/m² or less (e.g., 48 g/m² or less). The lower limit of the grammage of the surface protection sheet is not particularly limited. From the standpoint of the workability, etc., of removing the surface protection sheet adhered on an adherend, it is usually suitable to be 15 g/m² or greater, preferably 20 g/m² or greater, or more preferably 25 g/m² or greater (e.g., 30 g/m² or greater).

The surface protection sheet disclosed herein may have an overall thickness of 80 μm or smaller (e.g., 70 μm or smaller). Herein, the overall thickness of a surface protection sheet refers to the total thickness of a support substrate and a PSA layer. The surface protection sheet according to a preferable embodiment has an overall thickness of 60 μm or smaller. A surface protection sheet having such a small overall thickness is preferable because, for instance, in an embodiment where the surface protection sheet is wounds in a roll and included in a roll body, it allows reduction of the diameter of the roll body or inclusion of a longer length of the surface protection sheet in the roll body having the same diameter. From such standpoints, the surface protection sheet has an overall thickness of more preferably 55 μm or smaller or even more preferably 50 μm or smaller (e.g., 48 μm or smaller). The lower limit of the thickness of the surface protection sheet is not particularly limited. From the standpoint of the workability, etc., of removing the surface protection sheet adhered on an adherend, it is usually suitable to have an overall thickness of 15 μm or larger, preferably 20 μm or larger, or more preferably 25 μm or larger (e.g., 30 μm or larger).

The present description provides a protection sheet roll comprising a surface protection sheet disclosed herein wound in a roll. Typical examples of such a protection sheet roll include a protection sheet roll comprising a core and a surface protection sheet wrapped around the core. FIG. 2 shows a typical constitution of a protection sheet roll of this type. A protection sheet roll 100 comprises a core rod 20 and a long surface protection sheet 10 wrapped around it. The surface protection sheet 10 is typically wound, with the support substrate 1 facing outside, so that the adhesive face 2A contacts the back face 1B of the support substrate 1.

The shape of the core is not particularly limited. It can have a shape of, for example, a solid column, a hollow column (i.e., a cylinder), or a solid or hollow polygonal column, etc. From the standpoint of making a lighter protection sheet roll, can be preferably used a hollow columnar core or a hollow polygonal columnar core. A cylindrical core is particularly preferable.

The material constituting the core is not particularly limited, and a known material can be used. Examples include plastic materials such as PE resin, PP resin, vinyl chloride resin, polyester, epoxy resin, phenol resin, melamine resin, silicon resin, polyurethane, polycarbonate, acrylonitrile-butadiene-styrene copolymer resin (ABS resin), etc.; composite materials such as fiber-reinforced plastic (FRP), etc.; metallic materials such as iron, stainless steel (SUS), aluminum, etc.; and so on. From the standpoint of making a lighter protection sheet roll, can be preferably used a core constituted primarily with a plastic material. As the plastic material, in view of the balance between the lightness and the strength, ABS resin, PE resin or the like can be preferably used.

The diameter of the core is not particularly limited. A preferable core has a diameter of about 85 mm to 110 mm, or more preferably 85 mm to 100 mm. From the standpoint of making a lighter protection sheet roll, a core of about 85 mm to 95 mm diameter is preferably used. When the core has a non-circular cross section, the diameter of the core refers to the diameter of a circle obtained by approximation of the cross section.

When the core is hollow like a hollow column or a hollow polygonal column, based on the core material and its diameter or production conditions and the usage of the surface protection sheet, etc., the thickness of the outer wall can be suitably selected so as to obtain desirable strength. From the standpoint of making a lighter protection sheet roll, it is usually preferable that the outer wall has a thickness of about 5 mm to 15 mm, or more preferably about 5 mm to 10 mm.

The surface protection sheet included in the protection sheet roll disclosed herein is not particularly limited in the length. From the standpoint of efficient application of the surface protection sheet, it is more advantageous that the protection sheet roll contains a longer length of the surface protection sheet. This will result in less frequent replacement of a finished protection sheet roll to a new protection sheet roll, whereby the efficiency of applying the surface protection sheet to adherends can be increased. With respect to a protection sheet roll comprising a surface protection sheet intended to cover relatively large surface areas, such as surface protection sheets adhered to exterior paint films of automobile bodies, it is particularly meaningful to reduce the frequency of replacement of protection sheet rolls.

The surface protection sheet included in the protection sheet roll disclosed herein has a length of, for instance, preferably 100 m or longer or more preferably 200 m or longer (e.g., 250 m or longer). The upper limit of the length of the surface protection sheet is not particularly limited. In the protection sheet roll according to a preferable embodiment, the surface protection sheet contained in the protection sheet roll has a length of 500 m or shorter (typically 400 m or shorter, e.g., 300 m or shorter). Alternatively, the surface protection sheet contained in the protection sheet roll may have a length longer than 300 m (typically longer than 300 m, but 500 m or shorter, e.g., 350 m or longer, but 500 m or shorter).

In a preferable embodiment of the protection sheet roll disclosed herein, the protection sheet roll comprises a surface protection sheet having a length of 200 m or longer, with the protection sheet roll having a mass of 0.75 kg or less per 50 mm width of the surface protection sheet. As such, a protection sheet roll comprising a surface protection sheet having a prescribed length or a longer length while having a mass suppressed to a certain level or below provides great handling properties because of the lightness of the protection sheet roll, and it also leads to efficient application to adherends because the protection sheet roll contains a long length of the surface protection sheet.

Herein, “the mass of the protection sheet roll per 50 mm width of the surface protection sheet” refers to a mass corresponding to the mass of a 50 mm width slice of the protection sheet roll 100 obtained by cutting the sheet roll perpendicularly to the rotation axis as shown by imaginary lines in FIG. 2. For a protection sheet roll comprising a core, the mass of the protection sheet roll per 50 mm width of the surface protection sheet includes the mass of the core of 50 mm in the thickness (in the length in the rotation axis). As for the core, from the standpoint of making a lighter protection sheet roll, can be preferably used a core having a mass per 50 mm width of 80 g or less (more preferably 70 g or less, even more preferably 60 g or less). The lower limit of the mass of the core is not particularly limited. For instance, a core having a mass per 50 mm width of 30 g or greater can be used.

Matters disclosed by the present description include the following:

(1) A surface protection sheet comprising a PSA layer on a support substrate, wherein

the PSA layer has a thickness smaller than 10 μm (e.g., 2 μm or larger, but 8 μm or smaller), with the surface protection sheet exhibiting a holding time of 50 seconds or longer (preferably 100 seconds or longer, more preferably 200 seconds or longer) in a constant load peel test using, as an adherend, a painted plate prepared by coating a steel plate with an acid-epoxy crosslinked acrylic paint, with the test comprising:

pressure-bonding a 25 mm wide piece of the surface protection sheet to the adherend;

at 5 minutes after the pressure-bonding of the surface protection sheet, applying a 100 g load to a first edge of the surface protection sheet piece so as to yield a peel angle of 90°; and

measuring the time spent by the surface protection sheet piece after the application of the load until 5 cm thereof was peeled off.

(2) The surface protection sheet according to (1) above, further satisfying the property (B) described earlier.
(3) The surface protection sheet according to (1) or (2) above, wherein the PSA layer is constituted with a PSA comprising a base polymer and a tackifier resin.

In the surface protection sheet of (3) above, the base polymer is preferably a rubber-based polymer. It is preferable that the base polymer is not crosslinked. In a preferable embodiment, the rubber-based polymer is an isobutylene-based polymer (e.g., a polyisobutylene).

In the surface protection sheet of (3) above, the tackifier resin content (when several tackifier resins are contained, their total content) can be, for instance, greater than zero part by mass, but 3.0 parts by mass or less relative to 100 parts by mass of the base polymer. It is usually preferable to be greater than zero part by mass, but 1.0 part by mass or less. The tackifier resin content can be, for instance, 0.01 part by mass or greater. From the standpoint of preferably producing the effects by the tackifier resin, it is usually preferable to be 0.05 part by mass or greater (e.g., 0.1 part by mass or greater, typically 0.2 part by mass or greater) relative to 100 parts by mass of the base polymer.

(4) The surface protection sheet according to (3) above, wherein the PSA comprises a tackifier resin (Tₕₛ) having an SP value of 8.5 or larger as the tackifier resin.

In the surface protection sheet of (4) above, the tackifier resin (Tₕₛ) content can be, for instance, 0.2 to 1.0 part by mass (preferably 0.2 to 0.5 part by mass) relative to 100 parts by mass of the base polymer. In a preferable embodiment, the tackifier resin (Tₕₛ) content is greater than 0.3 part by mass, but 0.5 part by mass or less (e.g., 0.35 to 0.5 part by mass) relative to 100 parts by mass of the base polymer.

(5) The surface protection sheet according to any one of (1) to (4) above to be adhered to exterior paint films of automobiles or other vehicles.

### EXAMPLES

Several worked examples relating to the present invention are described below, but the present invention is not intended to be limited to these examples. In the description below, “parts” and “%” are based on the mass unless otherwise specified.

### Example 1

### (Sample A1)

A substrate-molding material mixture containing: 62 parts of a homopolypropylene (trade name “NOVATEC PP FY4” available from Japan Polypropylene Corporation), 15 parts of a propylene block copolymer (trade name “NOVATEC PP BC3H” available from Japan Polypropylene Corporation), 15 parts of an LLDPE (trade name “KERNEL KF380” available from Japan Polyethylene Corporation), 8.0 parts of highly weather resistant-type rutile titanium(IV) oxide (trade name “TIPAQUE CR-95” available from Ishihara Sangyo Kaisha, Ltd.) and 0.2 part of a photo-stabilizing agent under trade name “CHIMASSORB 9444FDL” (a hindered amine-based stabilizing agent) available from Nihon Ciba-Geigy K. K.; was melted and compounded in a film-forming device, and the resultant was extruded from the T-die thereof to form a PP resin film of 35 μm thickness. The back face (opposite to the face to be provided with a PSA layer) of this PP resin film was subjected to a release treatment where a long-alkyl-based release agent was applied to form a coating of about 0.05 μm thickness after dried to obtain a support substrate S1.

In toluene, were dissolved 100 parts of an isobutylene-based polymer as a base polymer, 0.4 part of trade name “DUREZ 19900” (p-tert-octylphenol resin, Mw 1300, SP value 11.2, softening point 90° C.) available from Sumitomo Durez Co., Ltd., as a tackifier resin to prepare a PSA solution of 12% NV. As the isobutylene-based polymer, were used two species under trade names “OPPANOL B-80” (Mw about 90×10⁴, Mn about 25×10⁴, Mw/Mn about 3.6) and “OPPANOL B-12SFN” (Mw about 7×10⁴, Mn about 2.6×10⁴, Mw/Mn about 2.7) both available from BASF Corporation at a mass ratio of 90:10.

The PSA solution was applied to the front face (the face without any release treatment) of the support substrate S1 and allowed to dry to form a 8 μm thick PSA layer. The application conditions were adjusted so that the adhesive face yielded an arithmetic mean roughness (Ra) in a range of 0.3 to 0.7 μm. A PSA sheet sample A1 was thus fabricated. The PSA sheet sample A1 had a total thickness of 43 μm for the support substrate S1 and the PSA layer combined, and a grammage of 41 g/m².

Due to the composition of the PSA solution, the PSA constituting the PSA layer of Sample A1 contained 0.4 part of a tackifier resin having a softening point below 120° C. (which corresponds to a tackifier resin (Tₕₛ) having a high SP value), but was free of a tackifier resin having a softening point of 120° C. or above.

### (Sample A2)

In the fabrication of Sample A1, the amount of the PSA solution applied was modified so that the resulting PSA layer had a thickness of about 5 μm. Otherwise in the same manner as Sample A1, a PSA sheet sample A2 was fabricated. The PSA sheet sample A2 had a total thickness of 40 μm for the support substrate S1 and the PSA layer combined, and a grammage of 38 g/m².

### (Sample A3)

As the tackifier resin in the fabrication of Sample A2, in place of 0.4 part of “DUREZ 19900”, was used 0.2 part of trade name “HARIESTER DS-130” (a rosin ester, softening point 130° C.) available from Harima Chemicals Group, Inc. Otherwise in the same manner as Sample A2, a PSA sheet sample A3 was fabricated.

### (Sample A4)

For the isobutylene-based polymer in the fabrication of Sample A2, the mass ratio of “OPPANOL B-80” to “OPPANOL B-12SFN” was modified to 75:25. The amount of “DUREZ 19900” used was modified to 0.1 part. Otherwise in the same manner as Sample A2, a PSA sheet sample A4 was fabricated.

### (Sample A5)

A substrate-molding material mixture containing 70 parts of “NOVATEC PP FY4”, 20 parts of “KERNEL KF380” and 10 parts of “TIPAQUE CR-95” was melted and compounded in a film-molding device, and the resultant was extruded from the T-die thereof to form a PP resin film of 40 μm thickness. The back face of this PP resin film was subjected to a release treatment where a long-alkyl-based release agent was applied to form a coating of about 0.05 μm thickness after dried to obtain a support substrate S2.

In the preparation of the PSA solution used for the fabrication of Sample A2, the mass ratio of “OPPANOL B-80” to “OPPANOL B-12SFN” was modified to 85:15. As the tackifier resin, were used 0.3 part of “DUREZ 19900” and 0.1 part of trade name “PENSEL D-160” (a polymerized rosin ester, softening point about 160° C., acid value 13 mgKOH/g) available from Arakawa Chemical Industries, Ltd. In addition, 0.5 part of trade name “TINUVIN 326” (a benozotriazole-based UV-absorbing agent) available from BASF Corporation as a UV-absorbing agent, 0.02 part of trade name “CHIMASSORB 9444FDL” (a hindered amine-based photo-stabilizing agent) available from Nihon Ciba-Geigy K. K. as a photo-stabilizing agent and 0.25 part of trade name “IRGANOX 1010” (a hindered phenol-based antioxidant) available from Nihon Ciba-Geigy K. K. as an antioxidant were dissolved relative to 100 parts of the base polymer in toluene to prepare a PSA solution of 12% NV.

This PSA solution was applied to the front face of the support substrate S2 and allowed to dry to form a 5 μm thick PSA layer. The application conditions were adjusted so that the adhesive face yielded an arithmetic mean roughness (Ra) in a range of 0.3 μm to 0.7 μm. A PSA sheet sample A5 was thus fabricated. The PSA sheet sample A5 had a total thickness of 45 μm for the support substrate S2 and the PSA layer combined, and a grammage of 43 g/m².

The PSA constituting the PSA layer of Sample A5 contained 0.3 part of a tackifier resin having a softening point below 120° C. and 0.1 part of a tackifier resin having a softening point of 120° C. or above relative to 100 parts of the base polymer.

### (Sample A6)

For the isobutylene-based polymer in the fabrication of Sample A2, the mass ratio of “OPPANOL B-80” to “OPPANOL B-12SFN” was modified to 75:25. The application conditions of the PSA solution was modified so that the PSA layer had a thickness of about 15 μm and the adhesive face had an arithmetic mean roughness (Ra) of about 0.8 μm. Otherwise in the same manner as Sample A2, a PSA sheet sample A6 was fabricated. The PSA sheet sample A6 had a total thickness of 50 μm for the support substrate S1 and the PSA layer combined, and a grammage of 48 g/m².

### (Sample A7)

As the isobutylene-based polymer in the fabrication of Sample A2, “OPPANOL B-80” was used solely. No tackifier resins were used. Otherwise in the same manner as Sample A2, a PSA sheet sample A7 was fabricated.

### (Sample A8)

In the fabrication of Sample A4, the application conditions of the PSA solution was modified so that the adhesive face had an arithmetic mean roughness (Ra) exceeding 1 μm. Otherwise in the same manner as Sample A4, a PSA sheet sample A8 was fabricated.

The resulting PSA sheet samples A1 to A8 were subjected to the following evaluation tests. Their results are shown in Table 1 along with specification summary of the PSAs according to the respective examples.

### [Constant Load Peel Test]

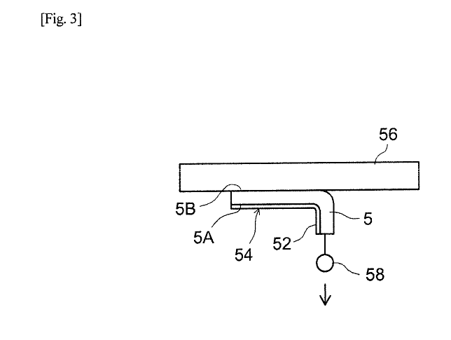

The PSA sheet sample according to each example was cut to a 25 mm wide by 150 mm long strip to prepare a test piece. In an environment at 23° C. and 50% RH, a painted plate was degreased with petroleum benzine, with the plate having been prepared by coating a steel plate with an acid-epoxy crosslinked acrylic paint (trade name “KINO 1210TW” available from Kansai Paint Co., Ltd.). As shown in FIG. 3, to a first face of the painted plate (adherend) 56, an adhesive face (a surface of PSA layer 5) 5B of a test piece 54 was adhered. The adhesion was carried out by pressure-boding the test piece by moving a 2 kg rubber roller specified in JIS Z 0237:2000 back and forth once at a rate of 3 m/min. After a lapse of 5 minutes from the pressure-bonding, the painted plate 56 was held horizontally with the surface having the test piece 54 facing down, and a 100 g load 58 was applied to a first edge 52 of the test piece so that the test piece 54 would be peeled at 90° angle. The holding time (seconds) spent by the test piece 54 after the application of the load 58 until 5 cm thereof was peeled off was measured. A longer holding time indicates that it has greater peel properties under a constant load and thus greater initial adhesiveness. It is noted that in FIG. 3, reference numeral 5A shows a second face of the PSA layer 5, which is on the support substrate side.

### [Arithmetic Mean Roughness (Ra) Measurement]

A 5 mm by 5 mm area of the adhesive face of each PSA sheet sample was subjected to arithmetic mean roughness (Ra) measurements using a non-contact three-dimensional surface topography measurement system under model number “Wyko NT-3300” (VSI mode set at objective lens: 2.5×, internal lens: 0.55×, back scan: 10 μm, length: 15 μm, threshold: 1%, window filtering: none) available from Veeco Instruments Inc. Five (n=5) measurements were carried out, and while excluding the maximum and minimum values, the mean value of three measurement data was determined.

### [Non-Contaminating Property Test]

Each PSA sheet sample was cut to a 25 mm wide strip to prepare a test piece. In a standard environment at 23° C. and 50% RH, a painted steel plate was wiped lightly with dry cloth and the test piece was adhered thereto, with the plate having been prepared by coating a steel plate with an acid-epoxy crosslinked acrylic paint (trade name “KINO 1210TW” available from Kansai Paint Co., Ltd.). The adhesion was carried out by pressure-boding the test piece by moving a 2 kg rubber roller specified in JIS Z 0237:2000 back and forth once at a rate of 3 m/min. The test piece was stored under the standard environment for 7 days. Subsequently, in the same environment, a test operator peeled the test piece away from the painted plate (adherend) by hand at a peel angle of about 90° and a peel rate of 100 mm/min. After this, it was evaluated by visual inspections as described below (after 7 days at 23° C.).

Another test piece adhered in the same manner to a plate coated with the acid-epoxy crosslinked acrylic paint was stored in a dry oven at 70° C. for 7 days. The test piece was then removed from the oven and left in the standard environment for over 2 hours. Following this, in the same environment, a test operator peeled the test piece away from the adherend by hand at a peel angle of about 90° and a peel rate of 100 mm/min. After this, it was evaluated by visual inspections as described below (after 7 days at 70° C.).

The paint film surface after removal of the test piece was visually inspected, and the degree of cloudy contamination (the degree of cloudiness) of the paint film was evaluated and assigned points ranging from 1 point (poor non-contaminating properties) to 4 points (no contamination found) with increments of 0.5. In this evaluation, a score of 2.5 points indicates a level of contamination that is minute and raises no practical issues (i.e., an acceptable level).

The degree of paint film contamination by the non-contaminating property test can also be evaluated by measuring with a suitable system the paint film color prior to the adhesion of the PSA sheet sample and the paint film color after the PSA sheet sample was removed, and detecting any difference in the paint film color (e.g., a difference in the lightness L) between the two.

The measurement can be carried out, using a multi-angle spectrophotometer under trade name “MA68II” available from X-Rite, Inc., with illuminant D65 at an observer angle of 10° with respect to aspecular angles of 15°, 25°, 45°, 75° and 110°. A score of 2.5 points based on the evaluation by visual inspections as described above corresponds approximately to a difference in the L value at 15° aspecular angle of 3.5 or greater, but less than 5.0. When the difference in the L value is 5.0 or greater, the score by visual evaluation generally turns out to be 2.0 points or lower. When the difference in the L value is less than 3.5, the score by visual evaluation is generally 3.0 points or higher.

### [Adhesive Transfer Resistance Test]

For deliberately creating a surface highly susceptible to adhesive transfers, the paint film surface prepared by coating a 45 cm by 30 cm steel plate with an alkyd-melamine-based paint (trade name “TM13RC” available from Kansai Paint Co., Ltd.) was polished with a polishing agent (trade name “HARD 5982-1-L” available from Sumitomo 3M Ltd.) at 1500 rpm across from north to south and east to west for 5 minutes, using an electric polisher (model number “PV7001C” available from Makita Corporation) equipped with a wool buff (trade name “959-721” available from Hitachi Koki Co., Ltd.). The polishing agent was subsequently removed from the surface using a finishing cotton flannel cloth, and the polished plate was used as the adherend. These procedures were carried out in a standard environment at 23° C. and 50% RH.

Each PSA sheet sample was cut into a 50 mm wide strip to prepare a test piece. The test piece was pressure-bonded to the adherend and the resultant was stored in the standard environment for 4 days. Subsequently, it was stored in an environment at −5° C. with higher likelihood to cause adhesive transfers for one hour, and in the same environment, a test operator peeled the test piece away from the adherend by hand at a peel angle of about 90° and a peeling speed of about 100 mm/min. The paint film surface after the peeling was visually inspected, and the percentage (%) of the area of the adherend surface with remaining PSA layer to the area over which the PSA sheet had been adhered was determined.

### [Light Transmittance Measurement]

With respect to each of support substrate S1 and S2, the average light transmittance was measured as follows:

Measurement system: spectrophotometer under model number “U-4100” available from Hitachi High-Technologies Corporation

Measurement conditions: measurement mode-applied detection, % T (transmittance) data mode, 750 nm/min scan rate, 1 nm sampling interval, automated slit control, photomultiplier voltage automated at 1, intensity control mode fixed, high resolution measurement OFF, no dimming film used, PbS sensitivity at 1, 10 mm cell length.

Measurement Method:

(i). The measurement system was turned on and kept in standby for 2 hours or longer to stabilize the system. Subsequently, without any sample set in, the baseline was measured.
(ii). A sample was then set in the transmittance measuring region of the measurement system, and under the measurement conditions listed above, the transmittance in a wavelength range of 300 nm to 350 nm was measured.

As for the results, the support substrate S1 had a 0.51% average light transmittance while the support substrate S2 had a 0.42% average light transmittance.

TABLE 1

| | | Sample | | | | | | | |
|---|---|---|---|---|---|---|---|---|---|
| | | A1 | A2 | A3 | A4 | A5 | A6 | A7 | A8 |
| Thikness of PSA layer (μm) | | 8 | 5 | 5 | 5 | 5 | 15 | 5 | 5 |
| Base polymer | Oppanol B12SFN (parts) | 10 | 10 | 10 | 25 | 15 | 25 | — | 25 |
| | Oppanol B80 (parts) | 90 | 90 | 90 | 75 | 85 | 75 | 100 | 75 |
| Tackifier resin | Durez19900 (parts) | 0.4 | 0.4 | — | 0.1 | 0.3 | 0.4 | — | 0.1 |
| | DS-130 (parts) | — | — | 0.2 | — | — | — | — | — |
| | D-160 (parts) | — | — | — | — | 0.1 | — | — | — |
| Surface roughness | Arithmetic mean roughness | 0.35 | 0.30 | 0.52 | 0.69 | 0.35 | 0.82 | 0.34 | 1.5 |
| | (Ra) (um) | | | | | | | | |
| Constant load peel test | Holding time (seconds) | 248 | 151 | 223 | 103 | 297 | 528 | 11 | 22 |
| Non-contaminating | After 7 days at 23° C. | 2.5 | 2.5 | 3.0 | 2.5 | 3.0 | 2.0 | 3.0 | 3.0 |
| properties | After 7 days at 70° C. | 2.5 | 2.5 | 3.0 | 3.0 | 3.0 | 2.5 | 3.5 | 3.0 |
| Adhesive transfer | Surface area left with | 20 | 0 | 10 | 10 | 5 | 40 | 0 | 0 |
| resistance | adhesive transfers (%) | | | | | | | | |

As shown in Table 1, in spite of that Samples A1 to A5 had a PSA layer having a thickness smaller than 10 μm (more specifically 8 μm or smaller), all exhibited a holding time of 50 seconds or longer (more specifically 100 seconds or longer) in the constant load peel test to, exhibiting great initial adhesiveness. According to Samples A1 to A3 and A5 with the adhesive face having an arithmetic mean surface roughness of 0.60 μm or smaller, even greater initial adhesiveness was obtained.

On the contrary, with Sample A8 having the same PSA composition and the PSA layer thickness as Sample A4 while having a surface roughness exceeding 1.0 μm on the adhesive face, the holding time in the constant load test was significantly shorter. With respect to Sample A6 having a PSA layer as thick as 15 μm, in spite of that the arithmetic mean roughness (Ra) of its adhesive face was larger than those of Samples A1 to A5, the holding time in the constant load peel test was longer. These results support that while the arithmetic mean roughness (Ra) does not greatly affect the initial adhesiveness and other adhesive properties when the PSA layer has a large thickness, the influence of the arithmetic mean roughness (Ra) becomes more significant when the thickness of the PSA layer is below 10 μm. Sample A7 using a non-crosslinked rubber-based PSA free of tackifier resins exhibited a short holding time in the constant load peel test and lacked initial adhesiveness.

Although specific embodiments of the present invention have been described in detail above, these are merely for illustrations and do not limit the scope of the claims. The art according to the claims includes various modifications and changes made to the specific embodiments illustrated above.

### INDUSTRIAL APPLICABILITY

The surface protection sheet according to the present invention is preferable when used in an embodiment where it is adhered to an adherend (an article to be protected) to serve a role to protect the surface of the adherend from damages and removed from the adherend after completed the protective role, with examples of the adherend including metal plates (steel plates, stainless steel plates, aluminum plates, etc.), painted metal plates having paint films on the surfaces (e.g., painted steel plates used for house building materials, other building materials, etc.), synthetic resin plates, articles molded from these, and so on. The paint protection sheet according to the present invention can be adhered to paint films of articles to be protected, which have been provided with paint works using paints of various compositions such as acrylic, polyester-based, alkyd-based, melamine-based, urethane-based, acid-epoxy crosslinked paints, or their composites (e.g., acrylic melamine-based, alkyd melamine-based paints, etc.) (with the articles to be protected being articles having paint films formed by the paint works, for example, automobile bodies, automotive components, metal plates such as steel plates and molded articles thereof, etc.), and used preferably as a means to protect the paint films from collisions with minute objects and contacts with chemicals, etc.

What is claimed is:

1. A surface protection sheet comprising a support substrate and a pressure-sensitive adhesive layer placed on the support substrate, wherein
the pressure-sensitive adhesive layer has a thickness smaller than 10 μm, and
the surface protection sheet exhibits a holding time of 50 seconds or longer in a constant load peel test using, as an adherend, a painted plate prepared by coating a steel plate with an acid-epoxy crosslinked acrylic paint, with the test comprising:
pressure-bonding a 25 mm wide piece of the surface protection sheet to the adherend;
at 5 minutes after the pressure-bonding of the surface protection sheet, applying a 100 g load to a first edge of the surface protection sheet piece so as to yield a peel angle of 90°; and
measuring, as the holding time, time spent by the surface protection sheet piece after the application of the load until 5 cm thereof was peeled off.

2. The surface protection sheet according to claim 1, wherein the pressure-sensitive adhesive layer has a surface having an arithmetic mean roughness (Ra) of 1.0 μm or smaller.

3. The surface protection sheet according to claim 1, wherein the pressure-sensitive adhesive layer is constituted with a pressure-sensitive adhesive comprising a non-crosslinked polymer as a primary component.

4. The surface protection sheet according to claim 1, wherein the pressure-sensitive adhesive layer is constituted with a pressure-sensitive adhesive comprising an isobutylene group represented by the following formula (I): 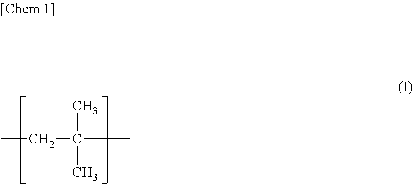
wherein the mass ratio of the isobutylene group to the pressure-sensitive adhesive is 5% or greater.

5. The surface protection sheet according to claim 1, wherein
the pressure-sensitive adhesive layer is constituted with a pressure-sensitive adhesive that comprises a tackifier resin having an SP value of 8.5 or larger, and
the tackifier resin has a mass ratio of 0.05% by mass to 5.0% by mass relative to the pressure-sensitive adhesive.

6. The surface protection sheet according to claim 1, wherein the support substrate has an average light transmittance of 10% or lower in a wavelength range of 300 nm to 350 nm.

7. The surface protection sheet according to claim 1, with the surface protection sheet having a mass per unit area of 60 g/m² or less.

8. A protection sheet roll comprising the surface protection sheet according to claim 1, wherein
the surface protection sheet is a long strip having a length of 200 m or longer and is wound in its length direction, and
the protection sheet roll has a mass of 0.75 kg or less per 50 mm width of the surface protection sheet.

9. The surface protection sheet according to claim 2, wherein the pressure-sensitive adhesive layer is constituted with a pressure-sensitive adhesive comprising a non-crosslinked polymer as a primary component.

10. The surface protection sheet according to claim 2, wherein the pressure-sensitive adhesive layer is constituted with a pressure-sensitive adhesive comprising an isobutylene group represented by the following formula (I): 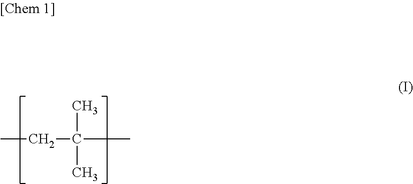
wherein the mass ratio of the isobutylene group to the pressure-sensitive adhesive is 5% or greater.

11. The surface protection sheet according to claim 2, wherein
the pressure-sensitive adhesive layer is constituted with a pressure-sensitive adhesive that comprises a tackifier resin having an SP value of 8.5 or larger, and
the tackifier resin has a mass ratio of 0.05% by mass to 5.0% by mass relative to the pressure-sensitive adhesive.

12. The surface protection sheet according to claim 2, wherein the support substrate has an average light transmittance of 10% or lower in a wavelength range of 300 nm to 350 nm.

13. The surface protection sheet according to claim 2, with the surface protection sheet having a mass per unit area of 60 g/m² or less.

14. A protection sheet roll comprising the surface protection sheet according to claim 2, wherein
the surface protection sheet is a long strip having a length of 200 m or longer and is wound in its length direction, and
the protection sheet roll has a mass of 0.75 kg or less per 50 mm width of the surface protection sheet.

15. The surface protection sheet according to claim 3, wherein the pressure-sensitive adhesive layer is constituted with a pressure-sensitive adhesive comprising an isobutylene group represented by the following formula (I): 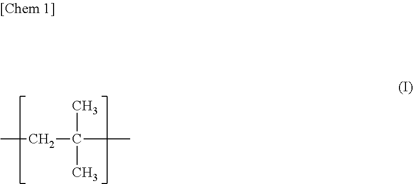
wherein the mass ratio of the isobutylene group to the pressure-sensitive adhesive is 5% or greater.

16. The surface protection sheet according to claim 3, wherein
the pressure-sensitive adhesive layer is constituted with a pressure-sensitive adhesive that comprises a tackifier resin having an SP value of 8.5 or larger, and
the tackifier resin has a mass ratio of 0.05% by mass to 5.0% by mass relative to the pressure-sensitive adhesive.

17. The surface protection sheet according to claim 3, wherein the support substrate has an average light transmittance of 10% or lower in a wavelength range of 300 nm to 350 nm.

18. The surface protection sheet according to claim 3, with the surface protection sheet having a mass per unit area of 60 g/m² or less.

19. A protection sheet roll comprising the surface protection sheet according to claim 3, wherein
the surface protection sheet is a long strip having a length of 200 m or longer and is wound in its length direction, and
the protection sheet roll has a mass of 0.75 kg or less per 50 mm width of the surface protection sheet.

20. The surface protection sheet according to claim 4, wherein
the pressure-sensitive adhesive layer is constituted with a pressure-sensitive adhesive that comprises a tackifier resin having an SP value of 8.5 or larger, and
the tackifier resin has a mass ratio of 0.05% by mass to 5.0% by mass relative to the pressure-sensitive adhesive.
